(19) United States
(12) Patent Application Publication
(10) Pub. No.: US 2024/0389046 A1
(43) Pub. Date: Nov. 21, 2024

(54) METHOD AND APPARATUS FOR CONTROLLING ENERGY USE IN WIRELESS COMMUNICATION SYSTEM

(71) Applicant: Samsung Electronics Co., Ltd., Gyeonggi-do (KR)

(72) Inventors: Jungshin PARK, Gyeonggi-do (KR); Dongeun SUH, Gyeonggi-do (KR)

(21) Appl. No.: 18/665,799

(22) Filed: May 16, 2024

(30) Foreign Application Priority Data
May 19, 2023 (KR) 10-2023-0065252

(51) Int. Cl. H04W 60/00; H04W 52/02

(52) U.S. Cl. CPC H04W 60/00; H04W 52/0212

(57) ABSTRACT

Methods and devices are provided in which an access and mobility management function (AMF) entity in a wireless communication system may receive, from a user equipment (UE), a registration request message including first information, and transmit to a unified data management (UDM) entity, a UE subscription request message including the first information. The AMF entity also receives, from the UDM entity, a UE subscription response message including second information on energy control for the UE, and transmits, to the UE, a registration response message including the second information.

### CROSS-REFERENCE TO RELATED APPLICATION(S)

This application is based on and claims priority under 35 U.S.C. § 119 (a) to Korean Patent Application No. 10-2023-0065252, filed on May 19, 2023, in the Korean Intellectual Property Office, the disclosure of which is incorporated herein by reference in its entirety.

### BACKGROUND

### 1) Field

The disclosure relates generally to a wireless communication system and, more particularly, to a method and an apparatus for controlling service-specific energy use of a user equipment (UE) in a wireless communication system.

### 2) Description of Related Art

5th Generation (5G) mobile communication technologies define broad frequency bands such that high transmission rates and new services are possible, and can be implemented not only in “sub 6 GHz” bands such as 3.5 gigahertz (GHz), but also in “above 6 GHz” bands referred to as millimeter wave (mmWave) including 28 GHz and 39 GHz. In addition, it has been considered to implement 6th Generation (6G) mobile communication technologies (referred to as beyond 5G systems) in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input-multiple output (MIMO) for mitigating radio-wave path loss and increasing radio-wave transmission distances in mmWave, supporting numerologies (e.g., operating multiple subcarrier spacings) for efficiently utilizing mm Wave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

With the development of a mobile communication system as described above, the wireless communication system has become more complex and capable of providing various services. As the number of devices used in the wireless communication system increases, there is a need for a function to improve the efficiency of energy consumed by a large number of devices in the wireless communication system without compromising the quality of service (QoS) for users.

The above information is presented as background information only to assist with an understanding of the disclosure. No determination has been made, and no assertion is made, as to whether any of the above might be applicable as prior art with regard to the disclosure.

### SUMMARY

The disclosure relates to a wireless communication system and, more specifically, to a method and an apparatus for controlling service-specific energy use of a UE in a wireless communication system.

According to an embodiment, an access and mobility management function (AMF) entity in a mobile communication system includes a transceiver and a controller coupled to the transceiver. The controller is configured to receive, from a UE, a registration request message including first information, and transmit, to a unified data management (UDM) entity, a UE subscription request message including the first information. The controller is also configured to receive, from the UDM entity, a UE subscription response message including second information on energy control for the UE, and transmit, to the UE, a registration response message including the second information.

According to an embodiment, a UE in a mobile communication system includes a transceiver and a controller coupled to the transceiver. The controller is configured to transmit, to an AMF entity, a registration request message including first information, and receive, from the AMF entity, a registration response message including second information, wherein the first information is transmitted to a UDM entity, and wherein the second information is received from the UDM entity.

According to an embodiment, a method performed by an SMF entity in a mobile communication system is provided. The SMF entity receives, from a UE, a PDU session establishment request message including first information, and transmits, to a PCF entity, a policy request message including the first information. The SMF entity also receives, from the PCF entity, a policy response message including second information indicating an energy policy for the UE, and transmits, to the UE, a PDU session establishment response message including the second information.

The technical subjects pursued in embodiments of the disclosure may not be limited to the above-mentioned technical subjects, and other technical subjects which are not mentioned may be clearly understood, through the following descriptions, by those skilled in the art to which the disclosure pertains.

Embodiments of the disclosure provide an apparatus and a method which can effectively provide services in a wireless communication system.

Advantageous effects obtainable from the disclosure may not be limited to the above-described effects, and other effects which are not mentioned may be clearly understood, through the following descriptions, by those skilled in the art to which the disclosure pertains.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a communication network including core network entities in a wireless communication system, according to an embodiment;

FIG. 2 is a diagram illustrating an example for controlling energy use for each user (for each UE) or energy use for each service used by a user in a wireless communication system, according to an embodiment;

FIG. 3 is a diagram illustrating a signal flow for controlling user-specific (UE-specific) energy use in a wireless communication system, according to an embodiment;

FIGS. 4A and 4B are diagrams illustrating a signal flow for controlling energy use for each service used by a user in a wireless communication system, according to an embodiment;

FIGS. 5A and 5B are diagrams illustrating a signal flow for controlling energy use of a specific network slice used by a user in a wireless communication system, according to an embodiment; and

FIG. 6 is a diagram illustrating a functional configuration of a core network entity in a wireless communication system, according to an embodiment.

### DETAILED DESCRIPTION

Hereinafter, embodiments of the disclosure will be described in detail with reference to the accompanying drawings. In the accompanying drawings, the same or like elements are designated by the same or like reference signs as much as possible. Furthermore, a detailed description of known functions or configurations that may make the subject matter of the disclosure unclear will be omitted. The terms which will be described below are terms defined in consideration of the functions in the disclosure, and may be different according to users, intentions of the users, or customs. Therefore, the definitions of the terms should be made based on the contents throughout the specification.

In describing the embodiments of the disclosure, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, the same or corresponding elements are provided with the same or corresponding reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). In some alternative implementations, the functions noted in the blocks may occur out of the order. For example, two blocks shown in succession may in fact be executed substantially concurrently or the blocks may sometimes be executed in the reverse order, depending upon the functionality involved.

As used herein, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, a “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by a “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

In the following description, some of terms and names defined in the 3rd generation partnership project long term evolution (3GPP LTE)-based communication standards (e.g., standards for 5G, NR, long term evolution (LTE), or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

The following detailed description of embodiments of the disclosure is mainly directed to NR as a radio access network (RAN) and packet core as a core network (5G system, 5G core network, or next generation core (NG Core)) which are specified in the 5G mobile communication standards defined by the 3GPP mobile communication standardization group, but based on determinations by those skilled in the art, the main idea of the disclosure may be applied to other communication systems having similar backgrounds or channel types through some modifications without significantly departing from the scope of the disclosure.

In 5G systems, a network data collection and analysis function (NWDAF), which is a network function (NF) for analyzing and providing data collected in a 5G network, may be defined to support network automation. The NWDAF may collect/store/analyze information from the 5G network and provide the result to at least one NF, and each NF may independently use the analysis result.

The 5G mobile communication system supports the NFs to use the result of collection and analysis of network-related data (hereinafter referred to as network data) through the NWDAF. This is intended to allow each NF to provide the collection and analysis of necessary network data in a centralized form in order to effectively provide its own functions. The NWDAF may collect and analyze network data by using a network slice as a basic unit. However, the scope of the disclosure is not limited to the network slice unit, and the NWDAF may additionally analyze various pieces of information (e.g., QoS) acquired from a UE, a PDU session, an NF status, and/or an external service server.

The result analyzed through the NWDAF may be delivered to each NF that has requested the corresponding analysis result, and the delivered analysis result may be used to optimize network management functions such as QoS guarantee/enhancement, traffic control, mobility management, and load distribution.

A unit node that performs the respective functions provided by the 5G network system may be defined as an NF (referred to as, for example, NF entity or NF node). Each NF may include at least one of, for example, an AMF for managing access of a UE to an access network (AN) and mobility of the UE, an SMF for performing session-related management, a user plane function for managing a user data plane, and a network slice selection function (NSSF) for selecting a network slice instance available for the UE.

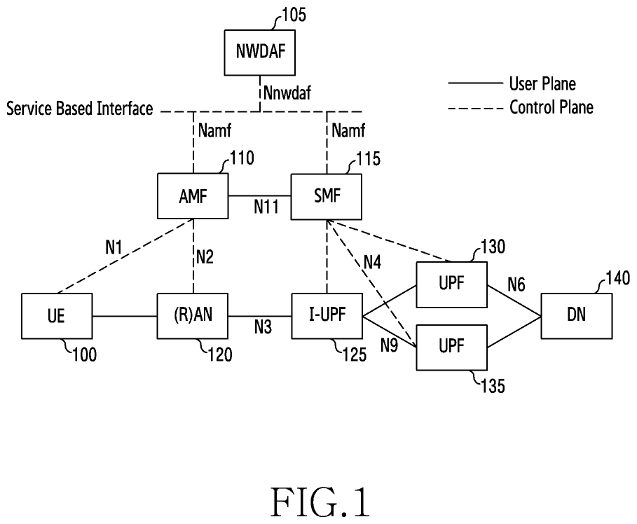

FIG. 1 is a diagram illustrating a communication network including core network entities in a wireless communication system, according to an embodiment. More specifically, FIG. 1 illustrates a wireless communication network including an NWDAF in a wireless communication system.

Referring to FIG. 1, an NWDAF 105 may collect network data in various manners from at least one source NF (e.g., NFs in a 5G core network such as an AMF 110, an SMF 115, user plane functions (UPFs) 130 and 135, and an intermediate-UPF (I-UPF) 125, an AF for efficient service provision, a network exposure function (NEF), or an operation, administration, and maintenance (OAM)). The AMF 110 may be connected to a UE 100 and a RAN 120, and the UPFs 130 and 135 and the I-UPF 125 may be connected to at least one data network (DN) 140 to transmit and receive user traffic of the UE 100, the user traffic being transmitted and received through the RAN 120.

The NWDAF 105 may provide analysis of network data collected from a network or the outside to at least one consumer NF. The NWDAF 105 may collect and analyze the load level of a network slice instance and provide information about the load level to the NSSF so that a specific UE may use the same for selection. A service-based interface defined in the 5G network may be used between the NFs 110 and 115 and the NWDAF 105 to request analysis information or transmit analysis information including an analysis result. A hypertext transfer protocol (HTTP) and/or JavaScript object notation (JSON) document may be used for the method of requesting for analysis information or transmitting analysis information. However, embodiments are not limited thereto.

Data collected by the NWDAF 105 may include at least one of an application identifier (ID), Internet protocol (IP) filter information, and a media/application bandwidth from a point coordination function entity, a UE ID and location information from the AMF 110, a destination data network name (DDN), a UE IP, a QoS flow bit rate, a QoS flow ID (QFI), a QoS flow error rate, and a QoS flow delay from the SMF 115, or a traffic usage report from the UPF.

The NWDAF 105 may additionally collect, in addition to the NFs configuring the core network, at least one of an NF resource status, an NF processing capability (e.g., throughput), and service level agreement (SLA) information from an OAM, which is an entity that may affect a connection between a UE and a service server, a UE status, UE application information, and a UE usage pattern from a UE, or a service application ID, a service experience, and a traffic pattern provided from an AF, and use the additionally collected information for analysis.

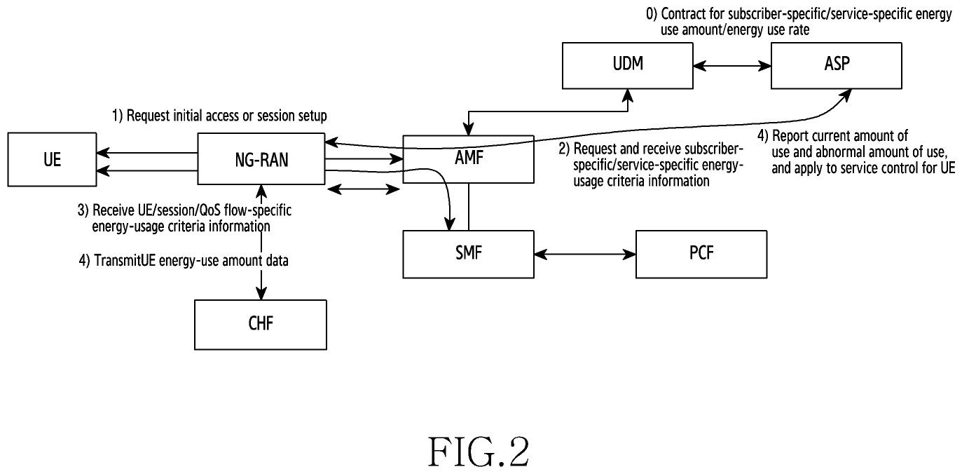

FIG. 2 is a diagram illustrating an example for controlling energy use for each user or service used by the user in a wireless communication system, according to an embodiment. Specifically, FIG. 2 illustrates a series of general operations in which entities each receive requirements for energy use for each user or service used by the user, apply the requirements to monitor energy use, and report the monitored energy use according to specified criteria in a wireless communication system.

At step 0, an application service provider (ASP) may provide an application service to a UE through a mobile communication network of a communication service provider, and may request a contract or control for energy use with a communication service provider from a specific UE (or multiple UEs) subscribed to the application service or a specific application service. The request for control of energy use from the ASP may include control of the total amount of energy used by a specific UE (or multiple UEs) or a specific application service, or control of a maximum energy use rate obtained by applying conditions such as a specific time, place, etc. Information including the control request described above may be stored, as subscriber information for the corresponding UE, in a UDM (or in a unified data repository (UDR)) of the mobile communication system from a server of the ASP through a contract with a communication service provider, or through a method designated by the service provider. The information including the control request described above may be directly transmitted from the server of the ASP to a PCF through the AF, instead of being stored in the UDM.

At steps 1 and 2, along with the process of receiving, from a UE subscribed to an application service, a message for requesting initial access to a mobile communication system or requesting to establish a session setup and processing the same, the AMF or SMF may request and receive the energy requirement information stored in the UDM.

At step 3, the AMF and SMF may transmit, to the NG-RAN, energy usage criteria and reporting criteria information per each session, slice, or QoS flow of a UE, which are used by the UE and an application service.

At step 4, the NG-RAN may report state information to a charging function (CHF) server, an AMF, or an SMF when energy use that exceeds designated usage criteria or meets reporting criteria is detected. The AMF and SMF that have received the state information may report energy use status and the like to a server designated by the ASP through an NEF or a PCF (or through direct communication). The ASP may perform additional operations, such as limiting services of a specific UE (or a plurality of UEs or at least one UE group) or updating a new policy on energy use with the communication service provider, based on the reported status information. The CHF server that has received the state information takes additional measures such as restrictions on UEs or services that exceed charging criteria, or notifies the ASP of the status to renew the contract or restrict the service.

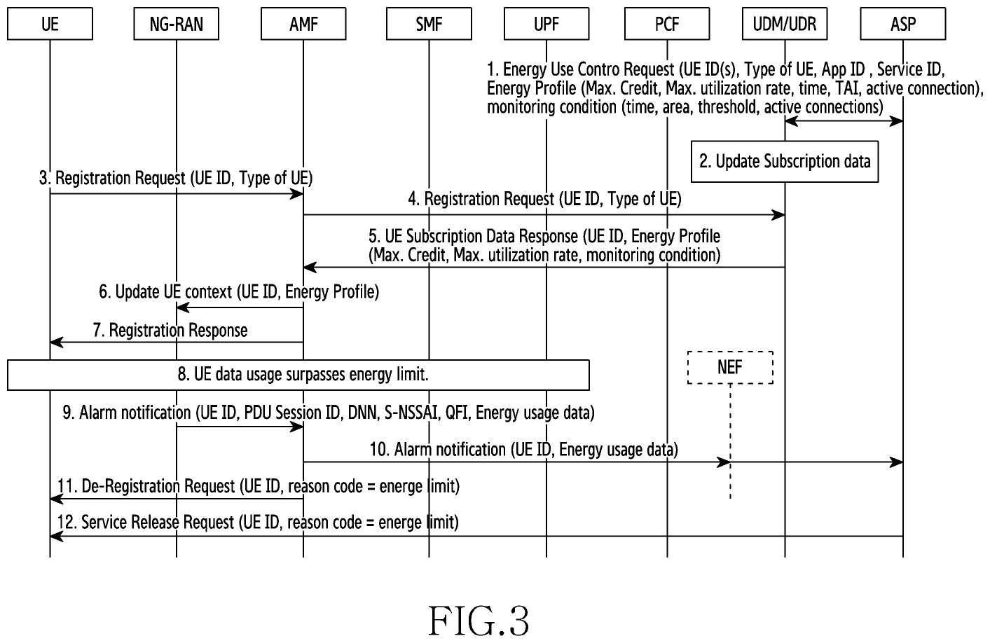

Referring to FIG. 2, the above-described pieces of information are only an example, and are not limited thereto, and only some of the listed information or additional information may be included. In addition, all of the above-described steps are unable to be considered essential components and are not limited thereto, and embodiments may include at least one of all, some, or a combination of some of the above-described steps. In addition, the steps in FIG. 2 may also be considered as general operations related to steps which will be described with reference to FIGS. 3 to 5, or may be performed in combination with the steps below.

FIG. 3 is a diagram illustrating a signal flow for controlling user-specific energy use in a wireless communication system, according to an embodiment. Specifically, FIG. 3 shows a series of signal procedure in which entities each receive requirements for energy use for each user (e.g., energy usage per specific UE) from an ASP, monitor energy use in a network according to energy usage criteria, and report the monitored energy use according to a designated condition in a wireless communication system. The ASP may be referred to as an application server or ASP. The ASP or the ASP may include an entity separately defined for an energy efficiency.

At step 1, the ASP may transmit an energy use control request message for designating a UE or service that requires control of energy use to a UDM (or a UDR) through a server, AF, and the like. The above-described message transmitted by the ASP may include information of at least one of a UE ID, a UE type, an application service ID, an energy profile, or a monitoring condition. The energy profile may include control information for at least one of a maximum energy use amount, a maximum energy use rate, a designated time, a designated area, or number of simultaneous connections. The maximum energy usage may include an energy limit (or energy credit limit) per UE (or group of UEs). In addition, the designated time may include a time to start controlling the energy limit or a time to end controlling the energy limit, and the designated area may include information on a serviced area for controlling the energy limit (e.g., a list of tracking areas (TAs)). The monitoring condition information may include information about at least one of time of use, area of use, a reporting criteria value, or a simultaneous connection criteria value.

At step 2, request information regarding control information may be stored in the UDR as subscriber information via the UDM. The UDR may update subscription information through the request information.

At step 3, the UE may transmit an initial access request (e.g., a registration request message) to the AMF. A message for requesting the initial access request transmitted by the UE may include at least one of a UE ID and information about a UE type.

At step 4, the AMF may request subscriber information for the UE from the UDM. A message for the subscriber information request transmitted by the AMF may include at least one of a UE ID and information about a UE type.

At step 5, the UDM may transmit a subscriber information response message for the UE to the AMF. The response message transmitted by the UDM may include energy control request information included in subscriber information. The energy control request information included in the subscriber information may include at least one of energy profile information or monitoring condition information stored in the UDM, as described above.

At step 6, the AMF may transmit UE context information to the NG-RAN or update the UE context information. Based on the energy profile, monitoring condition information, service provider configuration information, etc. received from the UDM, the AMF may determine information such as the energy profile, monitoring condition, etc. for energy use control for the corresponding UE and transmit the same to the NG-RAN. The NG-RAN may control the energy usage of the UE based on the information received from the AMF, and such control of energy usage may include various control actions related to the energy of the UE, such as resource allocation, energy monitoring, etc.

At step 7, the AMF may transmit, to the UE, an acceptance message (e.g., registration response message) for the initial access request.

At step 8, the NG-RAN may detect that use of energy by the UE has exceeded the designated energy usage criteria. The NG-RAN may monitor the energy usage criteria of the UE based on the received monitoring conditions. When use of data by the UE exceeds the energy limit criteria, the NG-RAN may identify that use of energy by the UE has exceeded a designated energy use condition. However, this is an example only, and whether the use of data by the UE has exceeded the energy limit may be identified by various entities, such as NG-RAN, NWDAF, or other entities concerned with energy efficiency.

At step 9, the NG-RAN may transmit an alarm notification to the AMF. The NG-RAN may transmit information indicating that use of energy by the UE has exceeded the usage criteria to the AMF. The information indicating that use of energy by the UE has exceeded the usage criteria, transmitted by the NG-RAN, may include information about at least one of a UE ID, PDU session ID, DNN, single-network slice selection assistance information (S-NSSAI), QFI, or energy use data.

At step 10, the AMF may transmit an alarm notification including information such as a UE ID or energy use data to the application server. The AMF may transmit information about abnormal use of the UE to the application server through the NEF or AF (or through direct communication).

At step 11, the AMF may, in order to restrict the network use of a UE that has exceeded the usage criteria, transmit a request for deregistration (e.g., a deregistration request message) to the UE. The deregistration request message transmitted by the AMF may include at least one of a UE ID and a reason code (e.g., cause value), and the reason code may include information about an excess of energy use, etc. The deregistration request message transmitted by the AMF, in addition to the reason code, may also include a specific UE-specific ID, as well as a UE group-specific ID that includes the specific UEs.

At step 12, the application server may transmit a request to stop service use (e.g., a service release request message) to the UE (or an application service client of the UE). The service release request message transmitted by the application server may include at least one of a UE ID and a reason code, and the reason code may include information about an excess of energy use, etc.

Referring to FIG. 3, the above-described pieces of information are only an example, embodiments are not limited thereto, and only some of the listed information or additional other information may be included. In addition, all of the above-described steps are unable to be considered essential components and are not limited thereto, and embodiments may include at least one of all, some, or a combination of some of the above-described steps. In addition, the name of each entity or information and a parameter is only an example, and is not limited thereto, and may be referred to by various names (e.g., a first node (entity), a second node (entity), etc.) that perform the same function (e.g., the UDM or UDR may also be referred to as an entity for data storage.).

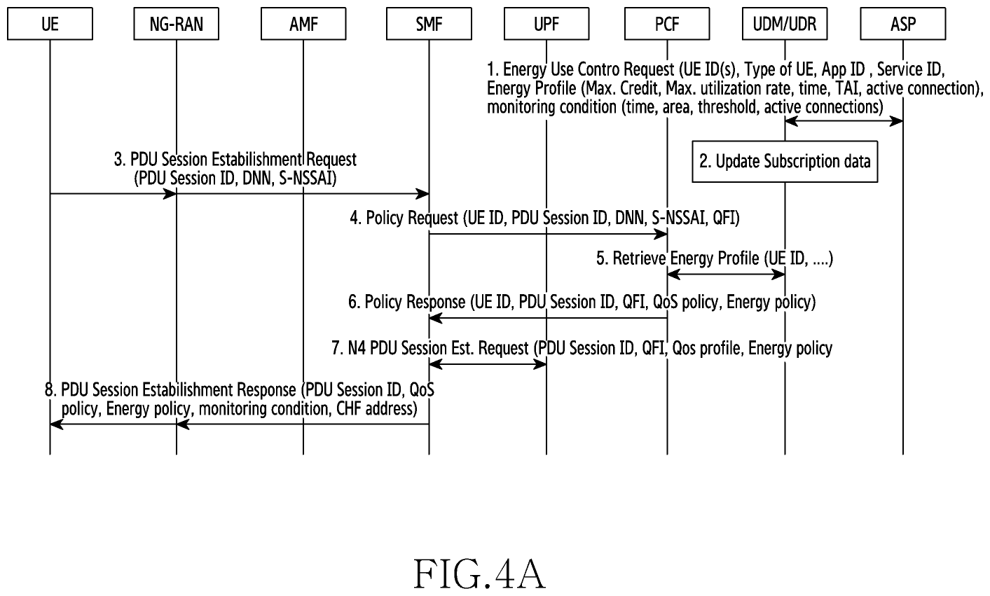

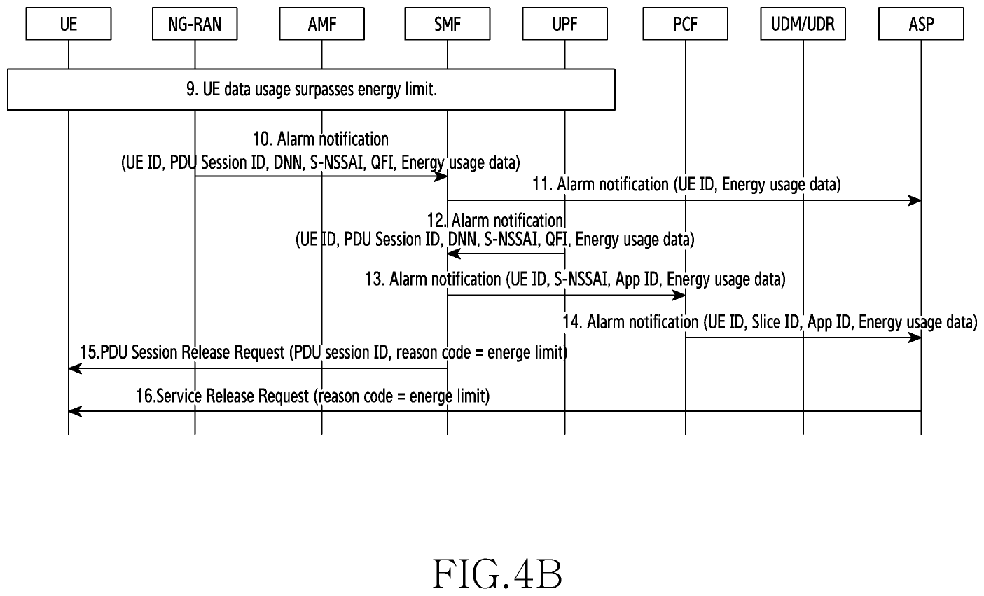

FIGS. 4A and 4B are diagrams illustrating a signal flow for controlling service-specific energy use in a wireless communication system, according to an embodiment. Specifically, FIGS. 4A and 4B show a series of signal procedures in which entities each receive requirements for service-specific energy use from an ASP, monitor energy use in a network according to energy usage criteria, and report the monitored energy use according to a designated condition in a wireless communication system. The ASP may be referred to as an application server or ASP. The ASP or ASP may include an entity separately defined for energy efficiency.

At step 1, the ASP may transmit an energy use control request message for designating a UE or service that requires control of energy use to a UDM (or a UDR) through a server, AF, and the like. The message transmitted by the ASP may include information of at least one of a UE ID, a UE type, an application service ID, an energy profile, or a monitoring condition. The energy profile may include control information for at least one of a maximum energy use amount, a maximum energy use rate, a designated time, a designated area, or number of simultaneous connections. The monitoring condition information may include information about at least one of time of use, area of use, a reporting criteria value, or a simultaneous connection criteria value. The maximum energy usage may include a per-service (or per PDU session) energy limit (or energy credit limit). In addition, the designated time may include a time to start control of the energy limit or a time to end control of the energy limit, and the designated area may include information on an area that is serviced to control the energy limit (e.g., a list of TAs).

At step 2, request information regarding control information may be stored in the UDR as subscriber information via the UDM. The UDR may update subscription information through the request information.

At step 3, the UE may transmit a PDU session establishment request to the SMF (or to the SMF via the NG-RAN). A message for the PDU session establishment request transmitted by the UE may include at least one of a UE ID, PDU session ID, DNN, or S-NSSAI.

At step 4, the SMF may transmit a policy request message to the PCF. The policy request message transmitted by the SMF may include at least one of a UE ID, PDU session ID, DNN, S-NSSAI, or QFI.

At step 5, the PCF may request UDR (or UDM) to retrieve information about the energy profile. The PCF may retrieve the energy profile from the UDR based on the policy request message received from the SMF. The PCF may further retrieve monitoring condition information. The energy profile may include control information for at least one of a maximum energy usage, a maximum energy use rate, a designated time, a designated area, or number of simultaneous connections. The monitoring condition information may include information about at least one of time of use, area of use, a reporting criteria value, or a simultaneous connection criteria value.

At step 6, the PCF may transmit a policy response message to the SMF. The policy response message transmitted by the PCF may include information about at least one of a UE ID, PDU session ID, QFI, QoS policy, or energy policy.

At step 7, the SMF and UPF may establish an N4 PDU session. The SMF may transmit an N4 PDU session establishment request message to the UPF based on the received policy response message. In the process of establishing an N4 PDU session, information about at least one of a PDU session ID, QFI, QoS profile, or energy policy may be transmitted, received, or used.

At step 8, the SMF may transmit a PDU session establishment response to the UE (or to the UE via the NG-RAN). The PDU session establishment response message transmitted by the SMF may include at least one of a UE ID, PDU session ID, QoS policy, energy policy, monitoring condition, or CHF address.

At step 9, the NG-RAN may detect that use of energy by the UE has exceeded designated energy usage criteria. The NG-RAN may monitor the energy usage criteria of the UE based on the received monitoring conditions. When use of data by the UE exceeds the energy limit criteria, the NG-RAN may identify that use of energy by the UE has exceeded the designated energy use condition.

At step 10, the NG-RAN may transmit an alarm notification to SMF. The NG-RAN may transmit information indicating that use of energy by the UE has exceeded the usage criteria to the SMF. The information indicating that use of energy by the UE has exceeded the usage criteria, transmitted by the NG-RAN, may include information about at least one of a UE ID, PDU session ID, DNN, S-NSSAI, QFI, or energy use data.

At step 11, the SMF may transmit an alarm notification including information such as a UE ID or energy use data to the application server. The SMF may transmit information about abnormal use of the UE to the application server through the PCF, NEF, AF, etc. (or through direct communication).

At step 12, the UPF may transmit, to the SMF, an alarm notification including at least one of a UE ID, PDU session ID, DNN, S-NSSAI, QFI, or energy use data.

At step 13, the SMF may transmit an alarm notification including at least one of a UE ID, S-NSSAI, at least one application ID (APP ID), and energy use data to the PCF.

at step 14, the PCF may transmit an alarm notification including at least one of a UE ID, a slice ID, at least one application ID, or energy use data to the application server. The PCF may transmit information about abnormal use of the UE to the application server through the NEF or AF (or through direct communication).

At step 15, the SMF may request the UE to release the PDU session (e.g., PDU session release request message) in order to restrict network use for the UE that has exceeded the usage criteria. The PDU session release request message transmitted by the SMF may include at least one of a PDU session ID and reason code, and the reason code may include information about an excess of energy use, etc.

At step 16, the application server may transmit a request to stop service use (e.g., a service release request message) to the UE (or an application service client of the UE). The service release request message transmitted by the application server may include at least one of a UE ID and a reason code, and the reason code may include information about an excess of energy use, etc.

With reference to FIGS. 4A and 4B, the above-described information is only an example and is not limited thereto, and only some of the listed information may be included or additional information may be included. In addition, all of the above-described steps are unable to be considered essential components and are not limited thereto, and various embodiments may include at least one of all, some, or a combination of some of the above-described steps. In addition, the name of each entity or information and a parameter is only an example, and is not limited thereto, and may be referred to by various names (e.g., a first node (entity), a second node (entity), etc.) that perform the same function (e.g., the UDM or UDR may also be referred to as an entity for data storage.).

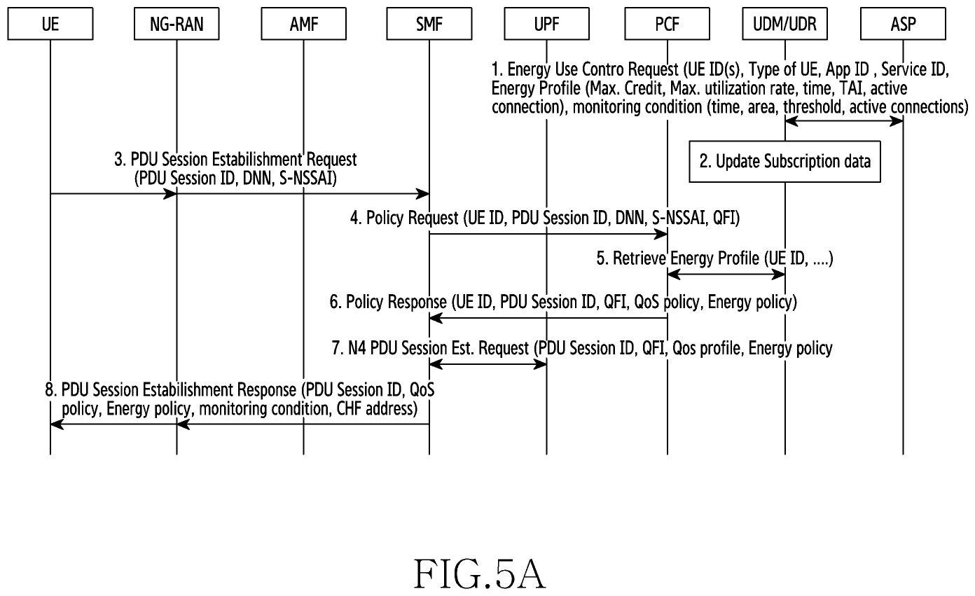

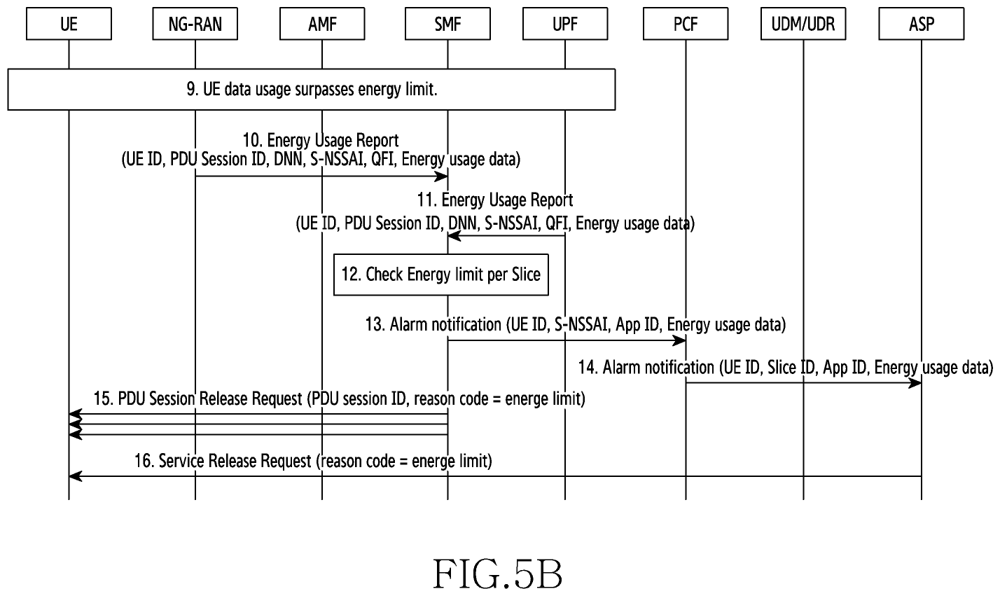

FIGS. 5A and 5B are diagrams illustrating a signal flow for controlling energy use of a specific network slice in a wireless communication system, according to an embodiment. Specifically, FIGS. 5A and 5B show a series of signal procedure in which entities each receive requirements for energy use in a particular contracted network slice from an ASP, monitor energy use in a network according to energy usage criteria, and report the monitored energy use according to a designated condition in a wireless communication system. The ASP may be referred to as an application server or ASP. The ASP may include an entity separately defined for energy efficiency.

At step 1, the ASP may transmit an energy use control request message for designating a UE or service that requires control of energy use to a UDM (or a UDR) through a server, AF, and the like. The message transmitted by the ASP may include information of at least one of a UE ID, a UE type, an application service ID, an energy profile, or a monitoring condition. The energy profile may include control information for at least one of a maximum energy use amount, a maximum energy use rate, a designated time, a designated area, or number of simultaneous connections. The monitoring condition information may include information about at least one of time of use, area of use, a reporting criteria value, or a simultaneous connection criteria value. The maximum energy usage may include a per-slice energy limit (or energy credit limit). Further, the designated time may include a time to start controlling the energy limit or a time to end controlling the energy limit, and the designated area may include information on a serviced area for controlling the energy limit (e.g., a list of TAs).

At step 2, request information regarding control information may be stored in the UDR as subscriber information via the UDM. The UDR may update subscription information through the request information.

At step 3, the UE may transmit a PDU session establishment request to the SMF (or to the SMF via the NG-RAN). A message for the PDU session establishment request transmitted by the UE may include at least one of a UE ID, PDU session ID, DNN, or S-NSSAI.

At step 4, the SMF may transmit a policy request message to the PCF. The policy request message transmitted by the SMF may include at least one of a UE ID, PDU session ID, DNN, S-NSSAI, or QFI.

At step 5, the PCF may request UDR (or UDM) to retrieve information about the energy profile. The PCF may retrieve the energy profile from the UDR based on the policy request message received from the SMF. The PCF may further retrieve monitoring condition information. The energy profile may include control information for at least one of a maximum energy usage, a maximum energy use rate, a designated time, a designated area, or number of simultaneous connections. The monitoring condition information may include information about at least one of time of use, area of use, a reporting criteria value, or a simultaneous connection criteria value.

At step 6, the PCF may transmit a policy response message to the SMF. The policy response message transmitted by the PCF may include information about at least one of a UE ID, PDU session ID, QFI, QoS policy, or energy policy.

At step 7, the SMF and UPF may establish an N4 PDU session. The SMF may transmit an N4 PDU session establishment request message to the UPF based on the received policy response message. In the process of establishing an N4 PDU session, information about at least one of a PDU session ID, QFI, QoS profile, or energy policy may be transmitted, received, or used.

At step 8, the SMF may transmit a PDU session establishment response to the UE (or to the UE via the NG-RAN). The PDU session establishment response message transmitted by the SMF may include at least one of a UE ID, PDU session ID, QoS policy, energy policy, monitoring condition, or CHF address.

At step 9, the NG-RAN may detect that use of energy by the UE has exceeded designated energy usage criteria. According to an embodiment, the NG-RAN may monitor the energy usage criteria of the UE based on the received monitoring conditions. When use of data by the UE exceeds the energy limit criteria, the NG-RAN may identify that use of energy by the UE has exceeded the designated energy use condition.

At step 10, the NG-RAN may transmit an energy usage report to SMF. According to an embodiment, the NG-RAN may transmit information indicating that use of energy by the UE has exceeded the usage criteria to the SMF. The information indicating that use of energy by the UE has exceeded the usage criteria, transmitted by the NG-RAN may include information about at least one of a UE ID, PDU session ID, DNN, S-NSSAI, QFI, or energy use data. FIG. 5B depicts only one SMF or UPF, but this is by way of example only, and the NG-RAN may exchange energy usage reports with one or more SMFs or UPFs for each of the slices, depending on the procedure for managing energy usage per slice.

At step 11, the UPF may transmit an energy usage report to the SMF. Information about the energy usage report transmitted by the UPF may include information about at least one of a UE ID, PDU session ID, DNN, S-NSSAI, QFI, or energy use data.

At step 12, the SMF may detect whether use of energy for each slice exceeds designated energy usage criteria. The SMF may detect whether the use of energy for each slice exceeds the designated energy usage criteria, based on information received from the NG-RAN and information received from the UPF. However, it is an example only and that exceedance of the specified energy usage criteria per slice described above may also be detected by the PCF or a separate entity defined for energy sensing. For example, FIG. 5B illustrates a process by which an exceedance of a slice-specific energy usage threshold is detected by the SMF, but this is an example and not a limitation; the PCF or a separate entity defined for energy sensing may also detect an exceedance of a slice-specific energy usage threshold and transmit the results to the SMF.

At step 13, the SMF may transmit, to the PCF, an alarm notification including at least one of a UE ID, S-NSSAI, at least one application ID, and energy use data. The PCF may receive the notification messages described above from one or more SMFs for each of the slices.

At step 14, the PCF may transmit, to the application server, an alarm notification including at least one of a UE ID, a slice ID, at least one application ID, or energy use data. The PCF may transmit information about abnormal use of the UE to the application server through NEF or AF (or through direct communication).

At step 15, the SMF may request the UE to release the PDU session (e.g., PDU session release request message) in order to restrict network use for the UE that has exceeded the usage criteria. The SMF may request to release the PDU session for at least one slice by transmitting a PDU session release request message. The PDU session release request message transmitted by the SMF may include at least one of a PDU session ID and reason code, and the reason code may include information about an excess of energy use, etc.

At step 16, the application server may transmit a request to stop service use (e.g., a service release request message) to the UE (or an application service client of the UE). The service release request message transmitted by the application server may include at least one of a UE ID and a reason code, and the reason code may include information about an excess of energy use, etc.

With reference to FIGS. 5A and 5B, the above-described pieces of information are only an example, and are not limited thereto, and only some of the listed information or additional information may be included. In addition, all of the above-described steps are unable to be considered essential components and are not limited thereto, and embodiments may include at least one of all, some, or a combination of some of the above-described steps. In addition, the name of each entity or information and a parameter is only an example, and is not limited thereto, and may be referred to by various names (e.g., a first node (entity), a second node (entity), etc.) that perform the same function (e.g., the UDM or UDR may also be referred to as an entity for data storage.).

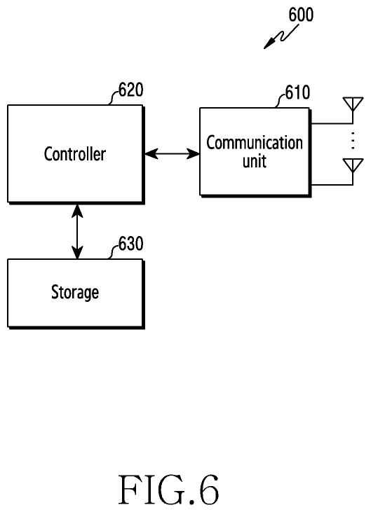

FIG. 6 is a diagram illustrating the configuration of a core network entity in a wireless communication system, according to an embodiment. A configuration 600 illustrated in FIG. 6 may be understood as a configuration of a device having a function of at least one of the core network entities 105, 110, 115, 120, 125, 130, 135, and 140 and the UE 100 of FIG. 1. Further, the configuration 600 exemplified in FIG. 6 may include a configuration of a device having a function of at least one of predetermined entities (or nodes) included in the core network. Hereafter, terms such as “ . . . unit,” or “ . . . er/or” used hereinafter indicates a unit of processing at least one function or operation, and may be implemented using hardware, software, or a combination of hardware and software.

Referring to FIG. 6, the core network entity includes a communication unit 610, a storage 630, and a controller 620.

The communication unit 610 provides an interface for communicating with other devices in the network. That is, the communication unit 610 converts a bit string transmitted from the core network entity to another device into a physical signal, and converts a physical signal received from another device into a bit string. That is, the communication unit 610 may perform signal transmission and reception. Accordingly, the communication unit 610 may be referred to as a modem, a transmitter, a receiver, or a transceiver. Here, the communication unit 610 allows the core network entity to communicate with other devices or systems through a backhaul connection (e.g., wired backhaul or wireless backhaul) or a network.

The storage 630 stores data such as basic programs, applications, and configuration information for the operation of core network entities. The storage 630 may be configured by a volatile memory, a non-volatile memory, or a combination of a volatile memory and a non-volatile memory. In addition, the storage 630 provides stored data according to a request of the controller 620.

The controller 620 controls the overall operations of the core network entity. For example, the controller 620 performs signal transmission and reception through the communication unit 610. Additionally, the controller 620 records and reads data in and from the storage 630. To this end, the controller 620 may include at least one processor or controller. According to various embodiments of the disclosure, the controller 620 may perform control such that synchronization using a wireless communication network is performed. For example, the controller 620 may perform control such that operations of the core network entity according to various embodiments are performed, as described above.

Embodiments may be operated through the controller 620 and the storage 630. Here, the controller 620 may be configured by one or more processors. The one or more processors may include functions of a general-purpose processor such as a CPU, an application processor (AP), and a digital signal processor (DSP), a graphics-dedicated processor such as a graphics processing unit (GPU) and a vision processing unit (VPU), or an artificial intelligence-dedicated processor such as a neural processing unit (NPU).

The configuration of the core network entity shown in FIG. 6 is only an example, and examples of network entities performing various embodiments of the disclosure from the configuration illustrated herein are not limited thereto. That is, some configurations may be added, deleted, or modified according to various embodiments.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Furthermore, a plurality of such memories may be included in the electronic device.

In addition, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Furthermore, the above respective embodiments may be employed in combination, as necessary. For example, one embodiment of the disclosure may be partially combined with any other embodiment to operate a base station and a UE. In addition, the embodiments of the disclosure may be applied to other communication systems and other variants based on the technical idea of the embodiments may also be implemented.

What is claimed is:

1. An access and mobility management function (AMF) entity in a mobile communication system, the AMF entity comprising:
a transceiver; and
a controller coupled to the transceiver, and configured to:
receive, from a user equipment (UE), a registration request message including first information,
transmit, to a unified data management (UDM) entity, a UE subscription request message including the first information,
receive, from the UDM entity, a UE subscription response message including second information on an energy control for the UE, and
transmit, to the UE, a registration response message including the second information.

2. The AMF entity of claim 1, wherein the controller is further configured to:
receive, from a base station, a notification message associated with an energy usage of the UE,
transmit, to an entity associated with an energy, the notification message, and
transmit, to the UE, a de-registration request message including third information on a reason for a de-registration.

3. The AMF entity of claim 1, wherein the first information includes at least one of an identifier (ID) of the UE or a type of the UE.

4. The AMF entity of claim 1, wherein the second information includes at least one of control information on an energy profile for the UE or monitoring information.

5. The AMF entity of claim 2, wherein the third information on the reason for the de-registration includes a cause value indicating an exceed energy credit limit.

6. The AMF entity of claim 4, wherein the energy profile for the UE includes at least one of energy credit limit per UE, information on a time for control of energy credit limit, or information on an area for control of energy credit limit.

7. The AMF entity of claim 6, wherein the information on the area for control of energy credit limit includes a list of tracking areas (TAs).

8. A user equipment (UE) in a wireless communication system, the UE comprising:
a transceiver; and
a controller coupled to the transceiver, and configured to:
transmit, to an access and mobility management function (AMF) entity, a registration request message including first information,
receive, from the AMF entity, a registration response message including second information, and
receive, from the AMF entity, a de-registration request message including third information on a reason for a de-registration,
wherein the first information is transmitted to a unified data management (UDM) entity, and
wherein the second information is received from the UDM entity.

9. The UE of claim 8, wherein the first information includes at least one of an identifier (ID) of the UE or a type of the UE.

10. The UE of claim 8, wherein the second information includes at least one of control information on an energy profile for the UE or monitoring information.

11. The UE of claim 8, wherein the third information on the reason for the de-registration includes a cause value indicating an exceed energy credit limit.

12. The UE of claim 10, wherein the energy profile for the UE includes at least one of energy credit limit per UE, information on a time for control of energy credit limit, or information on an area for control of energy credit limit.

13. The UE of claim 12, wherein the information on the area for control of energy credit limit includes a list of tracking areas (TAs).

14. A method performed by a session management function (SMF) entity in a mobile communication system, the method comprising:
receiving, from a user equipment (UE), a protocol data unit (PDU) session establishment request message including first information;
transmitting, to a policy control function (PCF) entity, a policy request message including the first information;
receiving, from the PCF entity, a policy response message including second information on an energy policy for the UE; and
transmitting, to the UE, a PDU session establishment response message including the second information.

15. The method of claim 14, further comprising:
receiving, from a base station or a user plane function (UPF) entity, a notification message associated with an energy usage of the UE;
transmitting, to the PCF entity, the notification message; and
transmitting, to the UE, a PDU session release request message including third information on a reason for a release.

16. The method of claim 14, further comprising:
receiving, from a base station or a UPF entity, an energy usage report message associated with an energy usage of the UE;
identifying that the energy usage of the UE exceeds an energy limit per slice;
transmitting, to the PCF entity, a notification message associated with an energy usage of the UE; and
transmitting, to the UE, a PDU session release request message including third information on a reason for a release.

17. The method of claim 14, wherein a N4 PDU session is established between the SMF and a UPF based on the second information.

18. The method of claim 14, wherein the first information includes at least one of an identifier (ID) of the UE, an ID of a PDU session, a data domain name (DNN), a single-network slick selection assistance (S-NSSAI), or a quality of service (QOS) flow ID (QFI).

19. The method of claim 14, wherein the second information includes at least one of policy information on an energy profile for the UE, monitoring information, or charging function (CHF) address information.

20. The method of claim 15, wherein the third information on the reason for the release includes a cause value indicating an exceed energy credit limit.
